(19) United States
(12) Patent Application Publication
(10) Pub. No.: US 2006/0254421 A1
(43) Pub. Date: Nov. 16, 2006

(54) Gas trap for drilling mud

(75) Inventor: Scott G. Boone, Houston, TX (US)

Correspondence Address: BAKER BOTTS, LLP, 910 LOUISIANA, HOUSTON, TX, 77002-4995, US

(73) Assignee: Epoch Well Services, Inc., Houston, TX (US)

(21) Appl. No.: 11/127,432

(22) Filed: May 12, 2005

(51) Int. Cl. B01D 19/00

(52) U.S. Cl. 95/260

(57) ABSTRACT

A method for liberating gas from drilling mud, the method having the following steps: agitating the drilling mud with an agitator powered by a motor, whereby gas is liberated from the drilling mud; enclosing the liberated gas in an enclosure; and pumping the liberated gas from the enclosure with a pump powered by the motor of the agitating. A gas trap having: an enclosure comprising an orifice through which fluid enters the enclosure; an agitator of fluid, positioned within the enclosure; a gas pump in fluid communication with the enclosure; and a motor in power transmitting communication with the agitator and the gas pump.

### BACKGROUND OF THE INVENTION

This invention relates to detection and measurement of gas entrapped in drilling fluids during oil well drilling operations. In particular, the invention relates to methods and apparatuses for extracting and sampling gas from the drilling fluids.

During drilling operations, drilling mud is pumped down the inner diameter of the rotating drill string. The drilling fluid lubricates and cools the drilling bit as it exits the bit at the bottom of the drill string. The drilling fluid carries cuttings to the surface up the annulus defined between the drill string and the borehole. Thus, the drilling fluid is circulated in a loop, wherein it is pumped from a mud tank, down-hole to the drilling bit, up-hole to the surface, and back to the mud tank.

As the drilling fluid is circulated down-hole, it entraps oil, gas and water from the penetrated earth formations. Gas entrained in the drilling fluid, such as carbon dioxide and hydrogen sulfide, may contain information indicative of formations containing hydrocarbons. Gas chromatography techniques have been used to separate and quantify different light hydrocarbon gases, such as methane through pentanes. Catalytic combustion, thermal conductivity, and flame ionization detectors have also been used to analyze the extracted gases. The gas content of the drilling fluid may also indicate the pore pressure of the drilled formation to assist in the identification of “oil shows” and “pay zones.” Drilling operators analyze the entrained gas: (1) to determine whether a formation of interest has been penetrated; and (2) to provide warning of dangerous underbalanced drilling conditions indicated by increased gas returns. This process is called “mud logging.”

To analyze the entrained gas, the gas is first extracted from the drilling fluid. Gas traps with mechanical agitators have been used to liberate the gas from the drilling fluid in a header tank before the drilling fluid flows into the main mud tank. The liberated gas is subjected to a gas analyzer to produce a signal whose value corresponds to the concentration of the component in the gas mixture. By measuring the carrier gas volume flowing into the mud/gas separation device, the flow rate of the mud into the separation device, and the component gas signal, a continuous concentration signal representing the concentration of the component gas in the drilling mud may be obtained.

Gas traps typically divert a portion of the mud returning from the well bore through an enclosure which provides some mechanism for gas release or separation. The release or separation mechanism may be passive, such as a mud-spreading plate, or may contain a mechanical agitator or vibrator to increase the mud/air contact. The liberated gas is transmitted to analytical equipment by a sample line attached to the enclosure of the trap. To provide continuously updated gas readings, mud residence time within the trap enclosure is typically very short. Only a fraction of the gas is liberated from the fluid. Gas traps designed to allow the observed gas in the sample stream to be easily related to the actual gas content of the return mud provide quantitative operation.

While the liberated gas is typically transmitted to analytical equipment by a sample line attached to the enclosure of the trap, pumps have been implemented to move the gas through the sample line. These pumps are usually positioned on the downstream side of the sample line and create a slight suction in the sample line and enclosure of the trap.

### SUMMARY OF THE INVENTION

This invention relates to detection and measurement of gas entrapped in drilling fluids during oil well drilling operations. In particular, the invention relates to methods and apparatuses for extracting and sampling gas from the drilling fluids.

According to one aspect of the invention, there is provided a method for liberating gas from drilling mud, the method having the following steps: agitating the drilling mud with an agitator powered by a motor, whereby gas is liberated from the drilling mud; enclosing the liberated gas in an enclosure; and pumping the liberated gas from the enclosure with a pump powered by the motor of the agitating.

Another aspect of the invention provides a gas trap having: an enclosure comprising an orifice through which fluid enters the enclosure; an agitator of fluid, positioned within the enclosure; a gas pump in fluid communication with the enclosure; and a motor in power transmitting communication with the agitator and the gas pump.

According to a further aspect of the invention, there is provided a mud logging system having: a gas trap made up of several components including: a means for enclosing a fluid; a means for agitating fluid inside the means for enclosing so that a gas is liberated from fluid and enclosed within the means for enclosing a fluid; a means for pumping the liberated gas from within the means for enclosing a fluid; and a single means for simultaneously transmitting power to the means for agitating and the means for pumping, and a gas detector.

The objects, features, and advantages of the present invention will be readily apparent to those skilled in the art upon a reading of the description of the embodiments which follows.

### BRIEF DESCRIPTION OF THE FIGURES

The present invention may be better understood by reading the following description of non-limitative embodiments with reference to the attached drawings wherein like parts of each of the several figures are identified by the same referenced characters, and which are briefly described as follows.

FIG. 1 is a perspective view of a gas trap of the present invention having an enclosure, a motor and a gas pump.

FIG. 2 is a side view of a gas trap of the present invention having an enclosure, a motor and a gas pump.

It is to be noted, however, that the appended drawings illustrate only typical embodiments of this invention and are therefore not to be considered limiting of its scope, as the invention may admit to other equally effective embodiments.

### DETAILED DESCRIPTION OF THE INVENTION

This invention relates to detection and measurement of gas entrapped in drilling fluids during oil well drilling operations. In particular, the invention relates to methods and apparatuses for extracting and sampling gas from the drilling fluids.

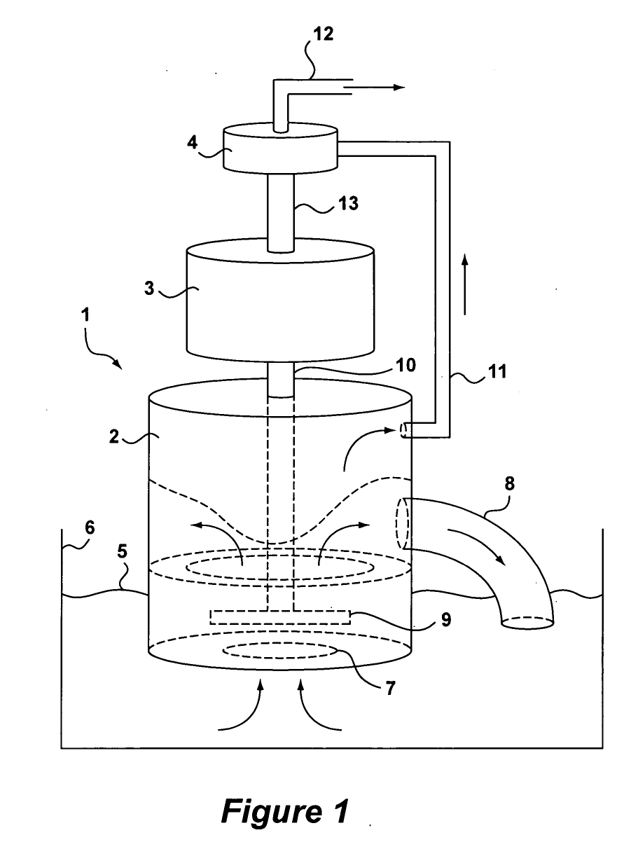

Referring to FIG. 1, a perspective view of a gas trap embodiment of the present invention is illustrated. The gas trap 1 has an enclosure 2, a motor 3 and a gas pump 4. The enclosure 2 is partially submerged into drilling mud 5, which is contained in a header tank 6. The enclosure 2 has an orifice 7 in its bottom to allow drilling mud 5 to flow through the orifice 7 into the interior of the enclosure 2. The enclosure 2 also has a mud return pipe 8 which extends from a side of the enclosure 2 which allows drilling mud 5 to flow from the interior of the enclosure 2 back to the header tank 6. An agitator drive shaft 10 extends from the motor 3 into the enclosure 2. An agitator 9 is attached to the distal end of the agitator drive shaft 10. The agitator 9 is positioned near the orifice 7 so as to swirl the drilling mud 5 as it enters through the orifice 7. The gas trap 1 also has a gas pipe 11 that extends from the enclosure 2 to the gas pump 4. A sample line 12 extends from the down stream side of the gas pump 4. A pump drive shaft 13 extends from the motor 3 and is connected to the gas pump 4.

The gas trap 1 operates by drawing a portion of the drilling mud 5 from the header tank 6 into the enclosure 2. The agitator 9 is rotated by the agitator drive shaft 10 and the motor 3. The agitator 9 swirls the drilling mud 5 as it is pulled through the orifice 7 in the bottom of the enclosure 2. As the drilling mud 5 is agitated within the enclosure 2, gas liberated from the drilling mud occupies the upper portion of the enclosure 2. After the drilling mud 5 has been agitated and has released at least a portion of the gas trap therein, the drilling mud 5 returns to the header tank 6 through the mud return pipe 8. The liberated gas collected in the upper portion of the enclosure 2 is drawn by the gas pump 4 out of the enclosure 2 through the gas pipe 11. The gas pump 4 then pumps the liberated gas through the sample line 12 to the gas analytical equipment or gas detector (not shown).

During operation of the gas trap 1, the motor 3 simultaneously drives the pump drive shaft 13 and the agitator drive shaft 10. Thus, flow of the drilling mud 5 through the enclosure 2 and flow of the liberated gas from the enclosure 2 to the sample line 12 are simultaneously powered by the motor 3.

In the illustrated embodiment, the agitator drive shaft 10 and the pump drive shaft 13 are rotated at the same speed because they are direct power outputs from the motor 3. In an alternative embodiment, a transmission is incorporated into the apparatus to modify the output speed of either the pump drive shaft 13 or the agitator drive shaft 10. Depending on the particular embodiment of the invention, the drive speed of the gas pump may be reduced or increased by implementing a transmission between the motor 3 and the gas pump 4. Similarly, the speed at which the agitator 9 is rotated may be reduced or increased by implementing a transmission between the motor 3 and the agitator 9.

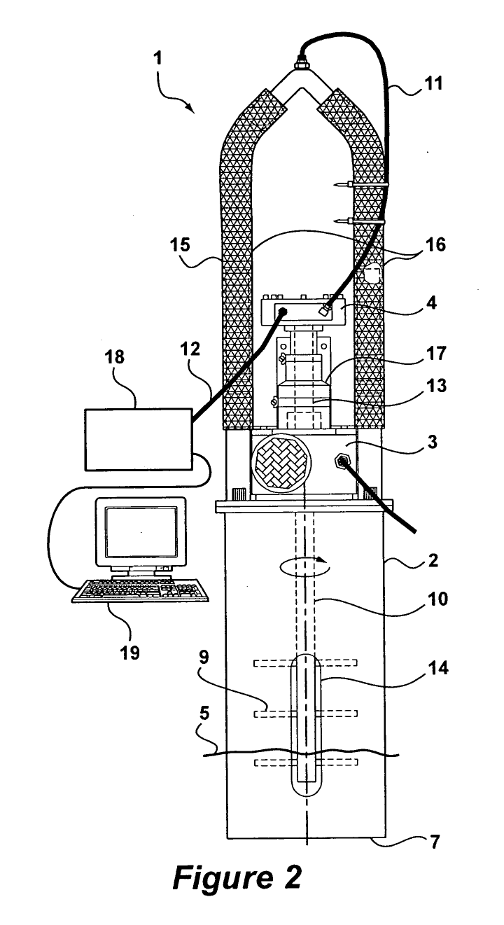

Referring to FIG. 2, a side view of an alternative embodiment of a gas trap is illustrated. The gas trap 1 has an enclosure 2, a motor 3, and a gas pump 4. The enclosure 2 is partially submerged in drilling mud 5. The enclosure 2 is a cylindrical shaped housing structure that has an open orifice 7 at the bottom. The enclosure 2 also has a plurality of vertical slits 14 in the side walls of the enclosure 2. An agitator drive shaft 10 extends from the top along the longitudinal central access of the enclosure 2. A plurality of agitators 9 extend from the agitator drive shaft 10 in the vicinity of the slits 14. The agitator drive shaft 10 is connected to the motor 3 so as to rotate the agitators 9. Two gas columns 15 extend from the top of the enclosure 2 on opposite sides of the motor 3. The gas columns 15 merge together at the top where a gas pipe 11 is connected to the gas columns 15 where the gas columns 15 merge. The opposite end of the gas pipe 11 is connected to the gas pump 4. The gas columns 15 also contain internal filters 16. The output of the gas pump 4 is connected to the sample line 12. A pump drive shaft 13 extends from the motor 3 to the gas pump 4. A drive guard 17 encircles the pump drive shaft 13 to prevent inadvertent contact with the rotating pump drive shaft 13.

The gas trap 1, illustrated in FIG. 2, operates by allowing drilling mud 5 to enter into the enclosure 2 through the orifice 7 and/or slits 14. The motor 3 rotates the agitator drive shaft 10 so that the agitators 9 stir the drilling mud 5 within the enclosure 2. As the drilling mud 5 is agitated, gas trapped within the drilling mud 5 is liberated and moves to the upper portion of the enclosure 2. By pump drive shaft 13, the motor 3 also drives the gas pump 4. The gas pump 4 draws gases from the upper portion of the enclosure 2 through the gas columns 15 and the gas pipe 11. The pump 4 creates a slight vacuum, relative to atmospheric pressure, so that the liberated gas in the upper portion of the enclosure 2 is drawn through the internal filters 16, the gas columns 15, and the gas pipe 11. The gas pump 4 then pumps the liberated gas under positive pressure through the sample line 12 to gas analytical equipment or gas detector 18. The gas analytical equipment may include any gas detector known to persons of skill including a gas chromatograph. In particular, it may include an explosion proof IR gas detector having a sample filter and water dropout. The gas detector 18 may output a signal in response to the detected gas level to a computer 19.

In alternative embodiments, the motor may be placed above both the gas pump 4 and the agitator 9. In particular, a pump drive shaft 13 may extend from the motor 3 down to the gas pump 4 and the agitator drive shaft 10 may extend from the gas pump 4 down to the agitator 9. In these embodiments, power is transmitted from the motor 4 to the agitator 9 through the gas pump 4, such that the gas pump 4 has drive shafts extending from both sides of the pump.

Many of the components of the gas traps of the present invention may be off-the-shelf parts manufactured by various entities known to persons of skill in the art. Further, the components may take a variety of forms and be made of various materials depending on the particular application of the gas trap. For example, the enclosure may take any form so as to allow fluid to flow through one portion of the enclosure and to allow liberated gas to collect in another portion of the enclosure. The enclosure may be made of metal, fiberglass, plastic, or any other material known to persons of skill in the art. The motor may be powered by compressed air, electricity, combustible fuel or any other power source known to persons of skill. The gas pipe and sample lines may be any size and material known to persons of skill. The internal filters in the gas columns may be any filters known to persons of skill capable of trapping solid particulates and allowing the liberated gas to pass therethrough.

Therefore, the present invention is well adapted to carry out the objects and attain the ends and advantages mentioned as well as those that are inherent therein. While the invention has been depicted and described with reference to embodiments of the invention, such a reference does not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A method for liberating gas from drilling mud, the method comprising:
agitating the drilling mud with an agitator powered by a motor, whereby gas is liberated from the drilling mud;
enclosing the liberated gas in an enclosure; and
pumping the liberated gas from the enclosure with a pump powered by the motor of the agitating.

2. A method as claimed in claim 1, wherein the agitating comprises rotating a drive shaft of an agitator with the motor.

3. A method as claimed in claim 1, wherein the pumping comprises rotating a drive shaft of the pump with the motor.

4. A method as claimed in claim 1, wherein the pumping comprises drawing the liberated gas from the enclosure with negative pressure, relative to ambient pressure, generated by the pump.

5. A method as claimed in claim 1, wherein the agitator and the pump are powered by a compressed air motor.

6. A method as claimed in claim 1, further comprising filtering the liberated gas after the gas exits the enclosure and before it enters the pump.

7. A method as claimed in claim 1, further comprising pumping the liberated gas to an analytical device under positive pressure, relative to ambient pressure, generated by the pump.

8. A gas trap comprising:
an enclosure comprising an orifice through which fluid enters the enclosure;
an agitator of fluid, positioned within the enclosure;
a gas pump in fluid communication with the enclosure; and
a motor in power transmitting communication with the agitator and the gas pump.

9. A gas trap as claimed in claim 8, further comprising a drive shaft connected between the agitator and the motor.

10. A gas trap as claimed in claim 8, further comprising a drive shaft connected between the gas pump and the motor.

11. A gas trap as claimed in claim 8, further comprising a drive shaft extending between the motor and the agitator through the gas pump.

12. A gas trap as claimed in claim 8, wherein the motor is a compressed air motor.

13. A gas trap as claimed in claim 8, further comprising a filter between the enclosure and the gas pump.

14. A gas trap as claimed in claim 8, further comprising a gas pipe extending between the enclosure and an input port of the gas pump.

15. A gas trap as claimed in claim 8, further comprising a sample line extending from an output port of the gas trap.

16. A mud logging system comprising:
a gas trap comprising:
a means for enclosing a fluid;
a means for agitating fluid inside the means for enclosing so that a gas is liberated from fluid and enclosed within the means for enclosing a fluid;
a means for pumping the liberated gas from within the means for enclosing a fluid; and
a single means for simultaneously transmitting power to the means for agitating and the means for pumping, and
a gas detector.

17. A mud logging system as claimed in claim 16, wherein the means for enclosing a fluid is a cylindrical enclosure having an orifice.

18. A mud logging system as claimed in claim 16, wherein the means for agitating is a shaft with arms extending from the shaft.

19. A mud logging system as claimed in claim 16, wherein the means for pumping is a gas pump.

20. A mud logging system as claimed in claim 16, wherein the means for simultaneously transmitting power is a compressed air motor.
